(19) United States
(12) Patent Application Publication
(10) Pub. No.: US 2016/0278544 A1
(43) Pub. Date: Sep. 29, 2016

(54) Holding Device and Bracket for Holding Device

(71) Applicant: Resource Integrated Ltd., Richmond Hill (CA)

(72) Inventors: Antony Rubino, Maple (CA); Grant Martin Musselman, Scarborough (CA); Kimberly M. Peach, Roseneath (CA)

(73) Assignee: Resource Integrated Ltd., Richmond Hill (CA)

(21) Appl. No.: 15/078,205

(22) Filed: Mar. 23, 2016

Related U.S. Application Data
(60) Provisional application No. 62/136,698, filed on Mar. 23, 2015.

(51) Int. Cl. A47F 5/08; F16M 13/02

(52) U.S. Cl. CPC A47F 5/0853; F16M 13/02

(57) ABSTRACT

Holding devices in the nature of display cradles are used extensively, particularly in the retail trade to display goods such as mobile devices in a manner which allows the consumer to easily and readily view and hold the device but at the same time provide a high degree of both mechanical grip to prevent the device from wobbling or becoming detached and security to prevent theft. One aspect of the disclosure provides a holding device for the display of an article. The holding device includes a central core and a plurality of brackets connectable to the central core. Each of the brackets has a respective outer end and comprising respective gripping means at the outer end for engaging and holding the article. The plurality of brackets are adjustable for lateral movement of the gripping means towards and away from said central core.

### RELATED APPLICATION

This application claims priority to U.S. Provisional Patent Application Ser. No. 62/136,698, filed Mar. 23, 2015, the entire content of which is incorporated by reference.

### FIELD OF THE DISCLOSURE

The present invention relates to holding devices, and more specifically to holding devices used to display articles such as mobile devices being offered for sale.

### BACKGROUND

Holding devices in the nature of display cradles are used extensively, particularly in the retail trade to display goods such as mobile devices in a manner which allows the consumer to easily and readily view and hold the device but at the same time provide a high degree of both mechanical grip to prevent the device from wobbling or becoming detached and security to prevent theft. Cradles to hold phones and tablet devices are well known in the market and there are a number of suppliers including Mobile Technologies Inc. RTF Global, Halometrics and Shopguard. Examples of prior art cradles are shown in the following patents and designs: CA 2784770, CA 2747529, U.S. Pat. No. D708,603, and U.S. Pat. No. D707,672.

Typically, cradles must be custom designed and manufactured for each new device. In a typical prior art device, the mobile device is mechanically gripped by a custom fitted bracket, the bracket itself being connected to a tethering device. The tethering device has an inner surface that faces the back of the mobile device and an outer surface that connects to an arm that elevates the device off of a table, counter top or other surface. The tethering device's inner surface is coated with an adhesive or fitted with adhesive tape to adhere to the back of the mobile device for added anti-theft or removal security. This system limits flexibility and creates substantial costs since the cradles must be replaced every time a new phone or tablet is displayed. It can take weeks or months for suppliers to produce a cradle for a new device and the need to customize the cradle adds considerable expense to its cost, not to mention the resulting redundancy of old cradles. Since many retailers operate hundreds or even thousands of stores nationwide, the cost of acquisition of a new cradle can be high.

A need therefore exists for a display device that is readily adaptable and adjustable to display existing phones and/or tablet devices, as well as new devices as they come along. It will be appreciated that the usefulness of the present display device is not limited to phones and tablet devices but can be used for any other consumer product that the retailer wishes to display.

### SUMMARY

Some embodiments of the present invention provide a display device that is adaptable and adjustable to hold and display mobile devices of different sizes, shapes and dimensions.

According to an aspect of the present invention then, there is provided a holding device for the display of an article, the holding device comprising a central core including first and second mounting blocks; first and second bracket means respectively and adjustably connectable to said first and said mounting blocks for lateral movement relative thereto towards and away from said central core; and gripping means at an outer end of each of said bracket means for engaging and holding the article.

In at least one embodiment of the present display device, the first and second bracket means are in the nature of mounting brackets that can slide back and forth relative to the mounting blocks that the bracket elements are affixed to, to allow the size of the display device to be fitted to the size of the device being displayed.

In an embodiment of the present display device, the first and second mounting brackets are secured to opposite corners of the displayed device, with the bracket extending from the back of the device to the front of the device.

In an embodiment of the present display device, the first and second mounting blocks further contain one or more elongated slots used to guide fasteners that connect the mounting brackets to the mounting blocks for sliding movement therebetween.

In an embodiment of the present display device, the first and second mounting blocks are adjustably connectable to the central core, such as a tethering device, to allow the central core to be moved towards the back of the device being displayed.

In another embodiment, the mounting brackets can be differently sized for holding smaller and larger articles.

According to one aspect, there is provided a holding device for display of an article, the holding device comprising: a central core; and a plurality of brackets connectable to the central core, each of said plurality of brackets having a respective outer end and comprising respective gripping means at the outer end for engaging and holding the article, wherein the plurality of brackets are adjustable for lateral movement of the gripping means towards and away from said central core.

In some embodiments, the plurality of brackets comprise first and second brackets, the central core having first and second opposite sides, and the first and second brackets being connectable to the first and second sides respectively.

In some embodiments, each of said brackets comprises: a respective first bracket piece that is connectable to said central core; a respective second bracket piece that is adjustably connected to the first bracket piece for said lateral movement, such that said plurality of brackets are adjustable to hold articles of different sizes.

In some embodiments, for each said bracket, the second bracket piece is slidably connected to said first bracket piece.

In some embodiments, for each said bracket, one of the first and second bracket pieces comprises an elongated slot, and the first and second bracket pieces are connected by a fastening member that extends through said slot, whereby said slot guides the sliding movement of the second bracket piece relative to the first bracket piece.

In some embodiments, for each said bracket, the fastening member movable within said slot for said lateral movement, and the fastening member is tightenable to hold said second bracket piece in a fixed position relative to the respective first bracket piece.

In some embodiments, said central core comprises a tethering member.

In some embodiments, the gripping means of each bracket is for engaging a respective corner of the article.

In some embodiments, the gripping means of each bracket comprises respective claws.

In some embodiments, the claws of each bracket comprise a respective first claw prong and a respective second claw prong, the first and second claw prongs for engaging perpendicular edges of the article at the respective corner.

In some embodiments, said central core has a peripherally extending side surface, a first end surface oriented to face the article being held and a second end surface spaced from said first end surface by said peripherally extending side surface.

In some embodiments, said plurality of brackets are connectable to said peripherally extending side surface of said central core.

In some embodiments, the first end surface of the central core is adjacent to a surface of the article when the article is held by the holding device, said central core comprising an adhesive layer on the first end surface.

In some embodiments, the central core further comprises a removable layer covering the adhesive layer.

In some embodiments, the holding device comprises first and second mounting blocks releasably attached to the central core, the plurality of brackets comprising first and second brackets respectively and adjustably connectable to said first and said mounting blocks for said lateral movement.

In some embodiments, said first and second brackets are slidably connectable to respective ones of said mounting blocks, such that said brackets are adjustable to hold articles of different sizes.

In some embodiments, each of said mounting blocks is formed with at least one elongated slot for receiving therethrough a fastening member connectable to a respective one of said brackets, whereby said slot guides the sliding movement of said bracket means.

In some embodiments, said fastening member is tightenable to hold said bracket means in a fixed position relative to its respective mounting block.

In some embodiments, said central core includes a tethering member, said mounting blocks being releasably and adjustably connectable to said tethering member.

In some embodiments, said first and second mounting blocks are removably connectable to said peripherally extending side surface of said tethering member.

According to another aspect, there is provided an adjustable bracket for a holding device comprising a central core, the adjustable bracket comprising: a first bracket piece that is connectable to said central core; and a second bracket piece having an outer end and comprising gripping means at the outer end for engaging and holding the article, said second bracket piece being adjustably connected to the first bracket piece for lateral movement of the gripping means towards and away from said central core, such that said bracket is adjustable to hold articles of different sizes.

In some embodiments, the bracket is connectable to a side of the central core.

In some embodiments, the second bracket piece is slidably connected to said first bracket piece.

In some embodiments, one of the first and second bracket pieces comprises an elongated slot, and the first and second bracket pieces are connected by a fastening member that extends through said slot, whereby said slot guides the sliding movement of the second bracket piece relative to the first bracket piece.

In some embodiments, the fastening member movable within said slot for said lateral movement, and the fastening member is tightenable to hold said second bracket piece in a fixed position relative to the respective first bracket piece.

In some embodiments, the gripping means of each bracket is for engaging a corner of the article.

In some embodiments, the gripping means comprises respective claws.

In some embodiments, the claws comprise a respective first claw prong and a respective second claw prong, the first and second claw prongs for engaging perpendicular edges of the article at the corner of the article.

According to another aspect, there is provided, a method of holding an article, comprising: providing a central core; providing a plurality of brackets connectable to the central core, each of said plurality of brackets having a respective outer end and comprising respective gripping means at the outer end for engaging and holding the article; attaching the plurality of brackets to the central core, wherein plurality of brackets are adjustable for lateral movement of the gripping means towards and away from said central core; placing the article in the brackets; adjusting the brackets such that the gripping means hold the article; and fixing the brackets in their respective positions holding the article.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying drawings, in which:

FIG. 1A is a bottom plan view of a holding device, according to one embodiment, and a larger sized mobile device for display;

FIG. 1B is another bottom plan view of the holding device and mobile device of FIG. 1A;

FIG. 2 is an exploded side view of mounting blocks and a central core forming a portion of the holding device of FIGS. 1A and 1B;

FIG. 3 is a top plan view of the mounting blocks and the central core of FIG. 2;

FIG. 4 is a partially exploded side elevational view of the mounting blocks, the central core and device holding mounting brackets;

FIG. 5 is a top plan view of the device of FIG. 3 with the device holding brackets connected to the mounting blocks;

FIG. 6A is a side elevational view of the assembled holding device;

FIG. 6B is another side elevation view of the assembled holding device, but connected the mobile device and also showing a central core positioned to adhere to the holding device.

FIG. 7 is a bottom plan view of the holding device according to another embodiment connected to a smaller sized mobile device for display;

FIG. 8 is a top plan view of mounting brackets adapted for use with the holding device of FIG. 7;

FIG. 9 is a partially exploded side elevational view of the holding device of FIG. 7;

FIG. 10 is a side elevational view of the holding device of FIG. 7 in a partially disassembled condition;

FIG. 11 is another side elevational view of the assembled holding device of FIG. 7 together with the smaller mobile device;

FIGS. 12A to 12D are a side elevational views mounting brackets according to some embodiments;

FIG. 13 is a top plan view of a holding device according to yet another embodiment;

FIG. 14 is a perspective view of a center core of the holding device of FIG. 13;

FIG. 15 is a bottom plan view of a mounting bracket of the device of FIG. 13;

FIG. 16 is a side view of the assembled holding device of FIG. 13;

FIG. 17 is a bottom view of the holding device of FIGS. 13 and 16 holding a mobile device;

FIG. 18 is a side view of the holding device and the mobile device of FIG. 17; and

FIG. 19 is a flowchart of a method according to some embodiments.

### DETAILED DESCRIPTION

Specific illustrative and non-limiting embodiments of the present holding or display device will now be described with reference to the figures.

It is to be understood that references to directions or orientations (such as “top”, “bottom”, “above”, “below” etc.) are for ease of description and are not intended to limit assembly or use of embodiments of the disclosure to any particular orientation.

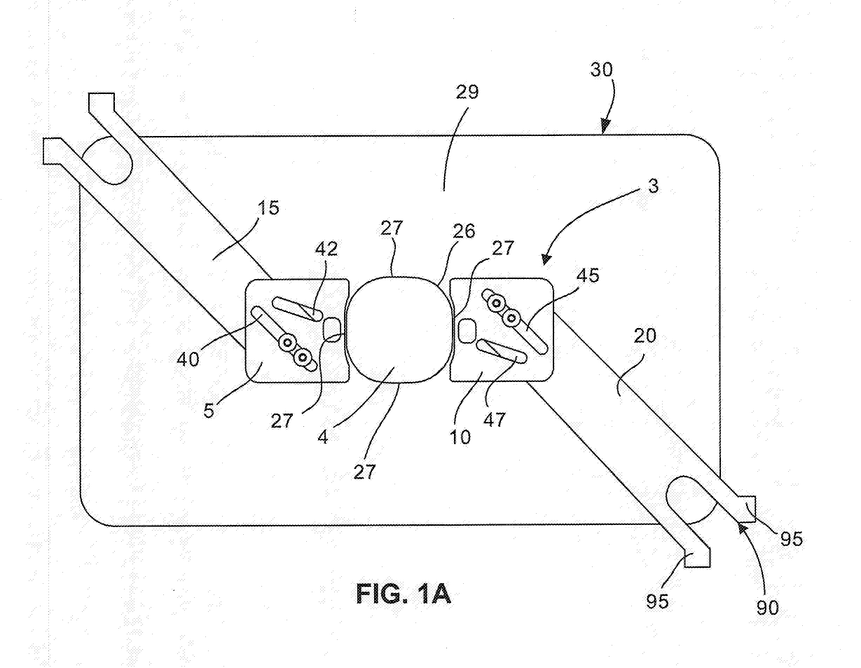

Referring initially to FIG. 1A, holding device 3 according to one embodiment of the present invention, for display of an article, is shown. The holding device 3 may be used for display of an article, such as a larger sized mobile device 30 (e.g. tablet), as shown in FIG. 1A. Other articles such as smart phones, music players, electronic picture frames, e-readers, etc. may optionally be held and displayed using the holding device 3. Embodiments are not limited to a particular type of article for display. Typical mobile devices that may be displayed include generally flat rectangular devices, such as smart phones or tablets.

The holding device 3 in FIG. 1A is shown connected to the rear surface 29 of the larger sized mobile device 30. The larger sized mobile device 30 in FIG. 1A may typically be a tablet computer, but can be any other device including, for example, notebooks and the like. Embodiments are not limited to any particular size or shape of mobile device being displayed.

In this embodiment, holding device 3 generally includes: a central core 4; mounting blocks 5 and 10 releasably connected to the central core 4; and brackets 15 and 20 releasably connected to mounting blocks 5 and 10. In this example embodiment, the core is in a generally cylindrical shape, although other shapes are possible. Any suitable core for attaching brackets for holding and displaying an article may be used. Furthermore, the central core may not be in the form of a tethering member in other embodiments. The brackets 15 and 20 are adjustably connected to the mounting blocks 5 and 10 and the brackets 15 and 20 are configured for holding an article (e.g. mobile device). The mounting brackets are adjustable for lateral movement of the gripping means towards and away from said central core. The central core 4 may include tethering means (not shown) for connecting to a tether or other means of securing the holding device to a display table, shelf or desk, for example.

As will be described below, brackets 15 and 20 are used to mechanically grip the mobile device 30. Central core 4 on the other hand includes, in some embodiments, an adhesive to bond to the rear surface 29 of the mobile device 30 for added anti-theft protection. The structure and design of the central core may vary. While two brackets 15 and 20 are shown in this example, more than two brackets (e.g. gripping four sides and/or corners of the mobile device) could be used in other embodiments.

The brackets 15 and 20 are respectively and adjustably connectable to the mounting blocks 5 and 10. The brackets 15 and 20 are laterally movable relative to the mounting blocks 5 and 10, both towards and away from the central core 4. Each of the brackets 15 and 20 has an outer end 90 and gripping means 95 at the outer end for engaging and holding the article. In FIG. 1A, the brackets 15 and 20 are shown in an extended state such that the mobile device 30 may be placed on the core 4. The brackets 15 and 20 may then be retracted toward the mounting blocks 5 and 10 to grip outer edges of the mobile device 30 and may then be tightened. As shown, the brackets 15 and 20 in this embodiment are elongated with a generally rigid ribbon-like structure, although the shape and structure of brackets may vary. Embodiments are not limited to a particular shape.

FIG. 1B shows the holding device 3 with the brackets 15 and 20 gripping the mobile device 30. As shown, the brackets 15 and 20 grip opposite corners 91 and 92 of the mobile device 30.

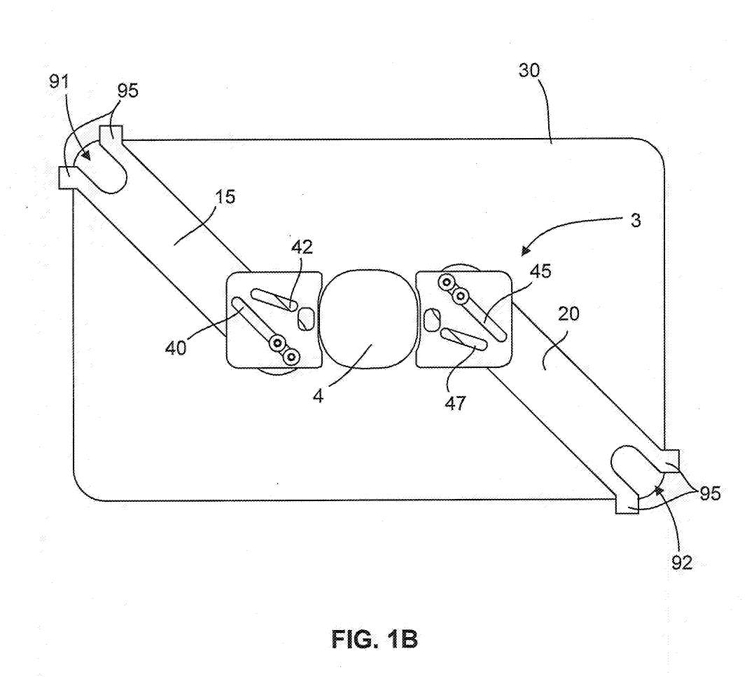

Reference is now made to FIG. 2 showing the core 4 and mounting blocks 5 and 10 in greater detail.

In this embodiment, the central core 4 is generally cylindrical in shape. However, as seen in FIGS. 1A and 1B, its vertical peripheral outer surface 26 is partially flattened to form sides 27 to facilitate its connection to mounting blocks 5 and 10. In this embodiment, there are four flattened sides 27 spaced evenly around the circumference of the central core 4, thereby forming two perpendicular pairs of opposing flattened sides 27. The shape of the central core may vary in other embodiments. For example, the number of flattened sides may vary or sides may not be flat. The central core also may not be generally cylindrical shaped. For example, a central core may be shaped as a rectangular prism, or any other shape suitable for connecting to brackets. Conventional cores for attaching to an article for display are available from MTI Industries and may be used or modified to be used with the brackets 15 and 20, for example. However, embodiments of the holding device described herein are not limited to any particular central core.

Turning again to FIG. 2, the central core 4 has an inner end 22 and an outer end 23. The inner end 22 will face an article (such as mobile device 30) when the article is attached. The outer end 23 faces away from the article. In some embodiments, inner end 22 is generally flat and includes an adhesive layer 35. The adhesive layer 35 may be, for example, a piece of two sided adhesive tape, one side adhering to inner end 22 and the other side for adhering to the article. Other types of adhesive layers may also be used. In this embodiment, the adhesive layer 35 adheres to the rear surface 29 of mobile device 30, as will be described below. In other embodiments, the central core may include different means to be affixed to the article (e.g. suction or physical connectors). In still other embodiments, the central core itself may not include any means for being affixed to the article.

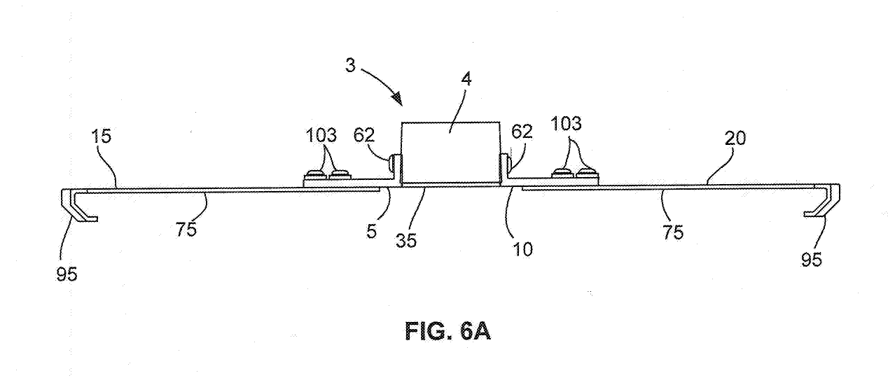

The outer end 23 of the central core may include a tethering mechanism (not shown) configured to be connected to a display arm or tether 9 or the like as seen in FIG. 6B which may elevate the holding device 3 and the mobile device being displayed above a countertop for more convenient and comfortable viewing by a prospective buyer. A tether may, for example, securely attach the holding device to a display case or table, for example.

Mounting blocks 5 and 10 have, in some embodiments, generally L-shaped profiles when seen from the side as in FIG. 2. Each of the mounting blocks 5 and 10 has a respective upper surface 50, a lower surface 55, an inner end 60, an outer end 65 and an orthogonally extending flange 70 extending in a direction away from the mobile device from the inner end 60 of the block. Each flange 70 is formed with at least one aperture 61 therethrough (shown in stippled lines in FIG. 2) for a fastener 62 which is used to releasably connect the mounting blocks 5 and 10 to respective ones of the flattened sides 27 on opposite sides of central core 4. The fastener 62 in this embodiment is a threaded screw, which is releasable, but other fastening means may also be used. For example, other attachment means such as a rivets, welding, bolts, adhesives, etc. may be used to mount the brackets to the central core in other embodiments. In the embodiment of FIG. 2, when screws 62 are loosened, central core 4 can be moved towards or away from the mobile device 30. When initially assembled, blocks 5 and 10 may be connected to central core 4 so that the block's upper surfaces 50 are coplanar or flush with the outer surface of adhesive layer 35. In some embodiments, the mounting blocks 5 and 10 may be integral with the core 4. For example, the central core 4 could be altered to include flanges with slots to act as mounting blocks. In other embodiments, the mounting blocks may be provided as part of brackets. For example, the mounting blocks 5 and 10 could be provided together with (either pre-assembled or for assembly) with the brackets 15 and 20 shown in FIGS. 1A and 1B. In this case, the mounting blocks 5 and 10 could be referred to as first bracket pieces, and the brackets 15 and 20 could be referred to as second bracket pieces.

An example tool 71 for tightening the screws 62 is shown in FIG. 2. The tool 71 may be, for example, an AllenCap security-type tool and the screws 62 (or any other screws described herein) may be AllenCap screws. However, embodiments are not limited to any particular method of tightening or loosening, or to any particular fastening means.

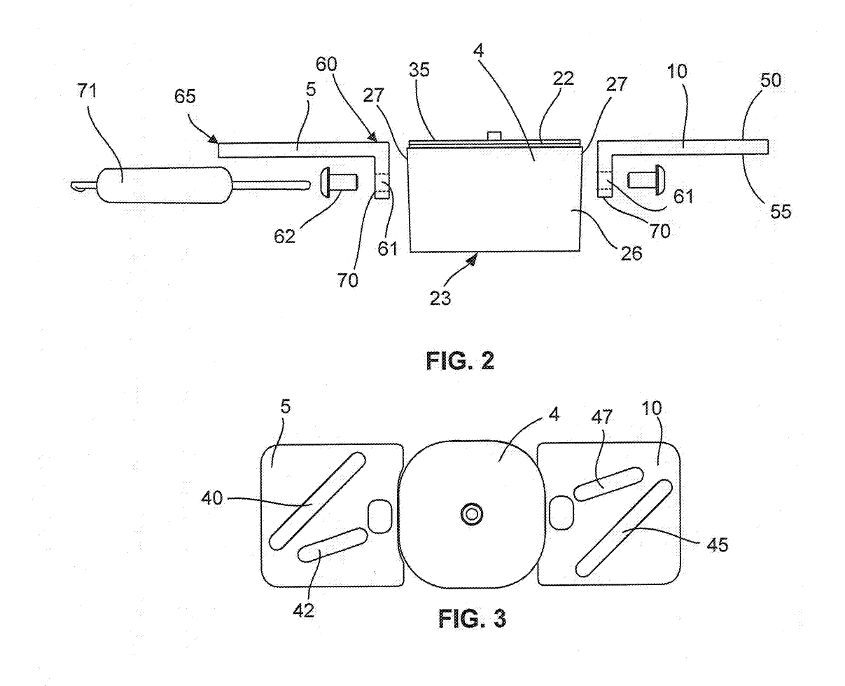

FIG. 3 is a top view of the assembled core 4 and mounting blocks 5 and 10. Each mounting block 5 and 10 is respectively formed with a first elongated diagonally extending slot 40 and 45. In this example, the mounting blocks 5 and 10 also each include a second non-parallel and shorter elongated slot 42 and 47. As will be explained below, the slots 40 and 45 allow adjustable lateral movement of the brackets 15 and 20 in this embodiment, while the other slots 42 and 47 allow same or different brackets to be adjusted for holding a different article. The number and arrangement of slots on the mounting blocks may vary in other embodiments. A mounting block may include only one slot, or may include two or more slots at varying angles with respect to one another. The angle(s) of slots may provide that brackets extend to the desired location (e.g. corners) of the article(s) for gripping. Multiple slots in the same mounting block may be parallel or non-parallel. The particular slots 40, 42, 45 and 47 are shown by way of example. Additionally, other means may be used for providing adjustable lateral positioning of brackets, and embodiments are not limited to slotted mounting blocks. The slots 40, 42, 45 and 47 in the mounting blocks 5 and 10 of this embodiment are also visible in FIGS. 1A and 1B. In other embodiments, slots may be included in brackets rather than the mounting blocks for providing the sliding movement.

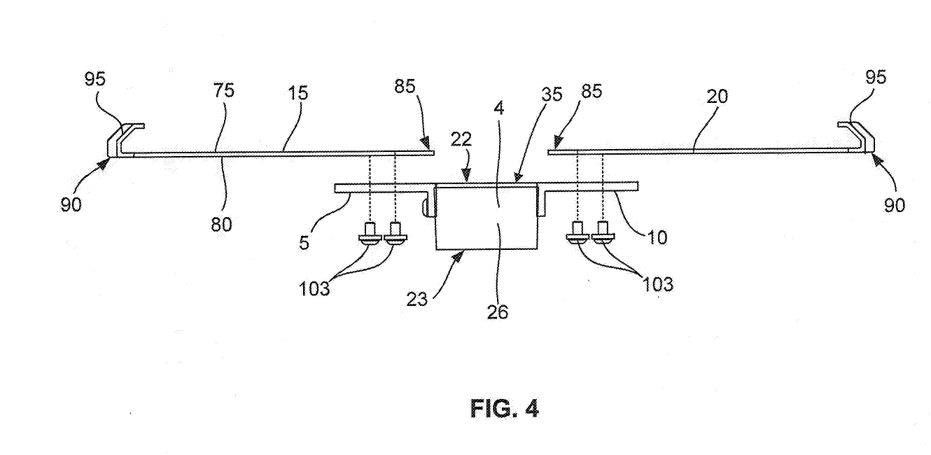

FIG. 4 is a side view of the holding device 3 and shows core 4 and mounting blocks 5 and 10 in their assembled condition adjacent to brackets 15 and 20 prior to assembly of the brackets 15 and 20 brackets to the mounting blocks 5 and 10. Each bracket 15 and 20 has an upper surface 75, a lower surface 80, an inner end 85, the outer end 90 and gripping means extending upwardly from the outer end 90. In this embodiment, the gripping means 95 is a clip or claw. However, other gripping means may be used in other embodiments.

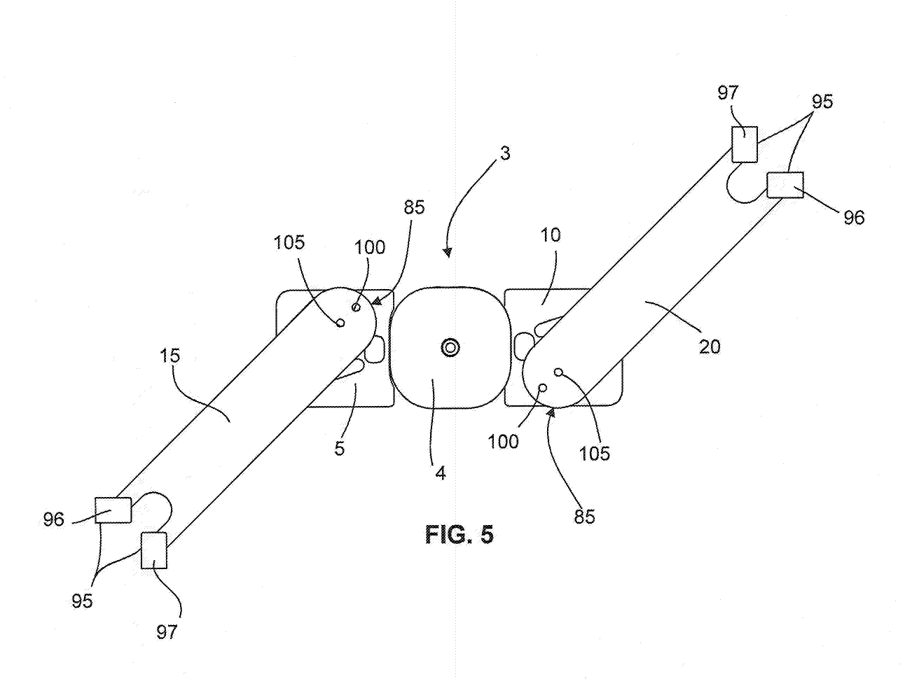

Brackets 15 and 20 are adjustably connected to respective mounting blocks 5 and 10 by one or two threaded fasteners such as screws 103. In this embodiment, the screws 103 are inserted through the longer slots 40 and 45 (shown in FIGS. 1A, 1B and 3) in the mounting blocks 5 and 10 for threading into threaded holes 100 and 105 (shown in FIG. 5) of the brackets 15 and 20. Before the screws 103 are tightened, brackets 15 and 20 can be slidably adjusted inward or outward laterally of mounting blocks 5 and 10 to allow claws 95 to engage the corners 91 and 92 of displayed device 30 (shown in FIG. 1B). Once the corners 91 and 92 are firmly engaged, and central core 4 may be centered over the back of displayed device 30, the screws 103 may be tightened to fix the brackets securely in place.

FIG. 5 is a top view of the holding device 3. As shown in FIG. 5, the claws 95 in this embodiment are split to engage the corners of displayed device 30. More particularly, each claw 95 is a fork-like structure with a first claw prong 96 and a second claw prong 97 to engage two perpendicular edges of the mobile device 30 at the corner 91 or 92. Each bracket 5 and 10 in this embodiment is formed with a pair of threaded screw holes 100, 105 adjacent inner end 85. Holes 100 and 105 are aligned in the longitudinal direction of the bracket. In this embodiment slots 40 and 45 (shown in FIG. 4) in the mounting blocks 5 and 10 align with screw holes 100 and 105 in the direction of the longitudinal axis of brackets 15 and 20. Accordingly, when both of screws 103 are used, brackets 15 and 20 are slidably adjustable in their longitudinal direction only. As noted above, other means may be used to adjustably attach the brackets 15 and 20 to the mounting blocks 5 and 10.

If, for example, it is desired to allow pivoting adjustment of the brackets 15 and 20 relative to blocks 5 and 10 to fit a particular device being displayed, only one screw 103 can be used to connect each bracket to its respective mounting block so that the brackets will be free to pivot relative to the block.

FIG. 6A is a side view of the assembled holding device 3 when holding the mobile device 30, and FIG. 6A also shows the display arm 9. Prior to connection to the mobile device 30, mounting blocks 5 and 10 may be securely tightened to central core 4 and brackets 15 and 20 may be loosely connected to blocks 5 and 10. The inner surfaces 75 of the brackets are proud of adhesive layer 35 in this example. The amount of offset between surfaces 75 and adhesive layer 35 isn't critical but it will typically be the thickness of the brackets themselves. At this stage, adhesive layer 35 is preferably covered by a releasable or removable layer (not shown), such as coated paper or plastic or any other suitable material that may be removed to expose the adhesive. This removable layer may be removed before the displayed device is mounted into the display device.

With the holding device 3 on the inner surfaces 75 of the brackets 15 and 20 and the core 4, the brackets 15 and 20 may be slidably adjusted (with the screws 103 sliding in the slots 40 and 45 shown in FIG. 3) until the claws 95 engage the corners 91 and 92 (shown in FIG. 1B) of the device 30. The central core 4 may be centered on the rear surface 29 of the mobile device (as shown in FIG. 6B). The screws 103 may then be tightened to secure the positions of the brackets 15 and 20 such that the device 30 is held by the holding device 3. With the mobile device 30 engaged by the brackets 15 and 20, screws 62 may be loosened which allows the central core 4 to be moved or pushed in the direction of rear surface 29 of displayed device 30. This contacts adhesive layer 35 to surface 29. Adhesive layer 35 may be, for example, any suitable adhesive to create a strong bond with the displayed device to deter theft. The bond need not be so strong that it can't be broken, but may be strong enough to prevent easy or casual detachment. Thus, the holding device 3 may provide a secure mechanical grip (via gripping means and possibly adhesive) to the mobile device 30. The adhesive layer may be omitted in other embodiments.

FIG. 6B shows the holding device 3 holding the mobile device 3. FIG. 6B also shows tether 9, which may attach to the outer end 23 of the core 4. The tether 9 may be used together with the holding device 3 for display of the mobile device, for example in a retail setting. For example, the tether 9 may be secured to a desk, and allow some movement of the mobile device, while the device is secured to the holding device. Any suitable tether type mechanism may be used. In other embodiments, a display arm or other display means may be connected to the holding device for display of the mobile device 30. Embodiments are not limited to any particular attachment of the holding device to a display or display area.

To remove the displayed device, screws 62 or screws 103 may be loosened, and brackets 15 and 20 may be moved outwardly to clear claws 95 from the corners of the mobile device 30. The display device can then be gripped and separated from central core 4. Alternatively, the screws 62 holding the mounting blocks 5 and 10 to the central core 4 may be loosened and removed to allow one or both of the brackets 15 and 20 to be removed. Embodiments are not limited to a particular order of screw tightening, adjustment and/or loosening to mount or remove the mobile device 30.

With the mobile device 30 removed, the holding device is now available for reuse with a different article (e.g. mobile device). In this regard, central core 4 may be fitted with a new layer of adhesive 35 or a new central core prefitted with an adhesive 35 can be substituted but either way, the present device may be readily reusable for a new or alternative displayed device, which may save the vendor a time and money compared to sourcing entirely new holding devices.

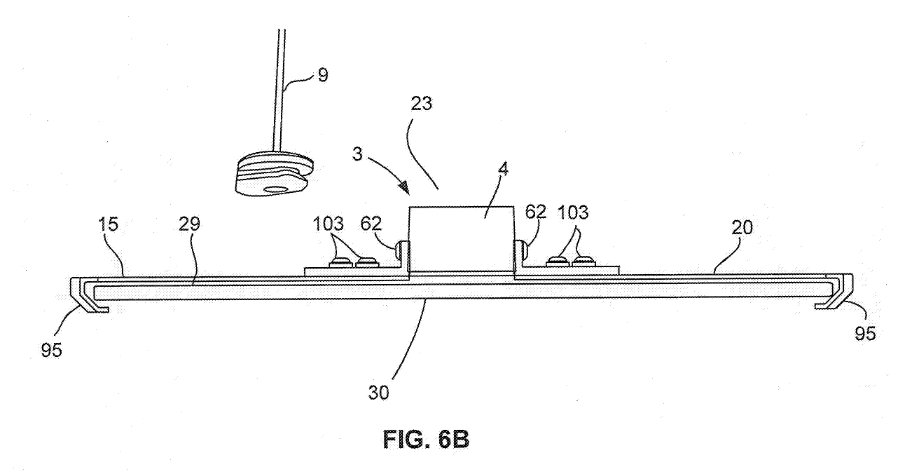

Another embodiment of a holding device 300 will now be described with reference to FIGS. 7 to 11. FIG. 7 is a bottom view of the device 300 holding a smaller sized mobile device 31. The holding device 300 is essentially a modification of the holding device 3 shown in FIGS. 1A and 1B to include shorter brackets 115 and 120 (rather than brackets 15 and 20 of the holding device 3 shown in FIGS. 1A and 1B) with like numerals used to identify like elements.

The smaller sized mobile device 31 in this example is a mobile phones, but other smaller devices such as music players, GPS navigators and the like may be held and displayed using the holding device 300. Although the holding device shown in FIGS. 7 to 9 allows for the display of smaller mobile devices, it provides the similar use and functionality as the display device 3 described above with reference to FIGS. 1A to 6B.

FIG. 7 shows holding device 300 connected to the smaller sized mobile device 31, the display device uses the shorter brackets 115 and 120. The holding device 300 also includes the same core 4 and mounting blocks 5 and 10 as the device 3 shown in FIGS. 1A and 1B. The mobile device 31 is mounted on its rear surface 32 to the holding device 300 in a manner similar to the mobile device 30 and holding device 3 of FIGS. 1A to 6B.

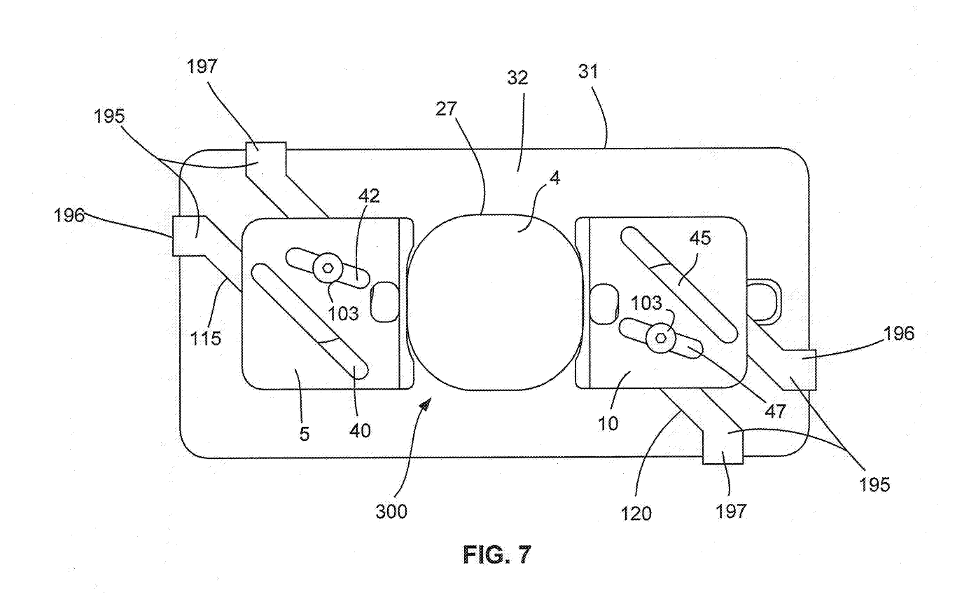

The brackets 115 and 120 in this embodiment are similar to the brackets 15 and 20 shown in FIG. 5, for example, but shorter. Furthermore, the brackets 115 and 120 have their screw holes 101 and 106 (shown in FIG. 8) arranged orthogonally to the bracket's longitudinal axis, one of the holes 101 being on or near the axis and the other hole 106 being offset from the axis by a predetermined distance. It is to be understood that the number and arrangement of holes in the brackets 115 and 120 may vary, and embodiments are not limited to the particular structure shown in FIGS. 7 and 8. Likewise, a different means for attaching the brackets to the mounting blocks 5 and 10 may be used (e.g. welding or rivets).

Brackets 115 and 120 are adjustably connected to respective mounting blocks 5 and 10 by a threaded fastener such as screws 103. The screws 103 are inserted through shorter slots 42 and 47 into one of holes 101 or 106 (shown in FIG. 8) depending on the shape and size of the device being displayed.

FIG. 8 is a top view of the shorter brackets 115 and 120 of this embodiment in isolation. As seen in FIGS. 7 and 8, the brackets 115 and 120 each include a gripping claws 195, which in turn includes first and second claw prongs 196 and 197. The claws 195 engage corners of the mobile device 31 similar to the claws 95 of the device 3 described with respect to FIGS. 1A to 6B. As also described above, other gripping means may also be used. For example, a gripping claw may include a single claw prong that is rounded or angled to fit around a corner. A clamping mechanism in place of a claw could also be used as part of a bracket. Any suitable gripping means may be utilized.

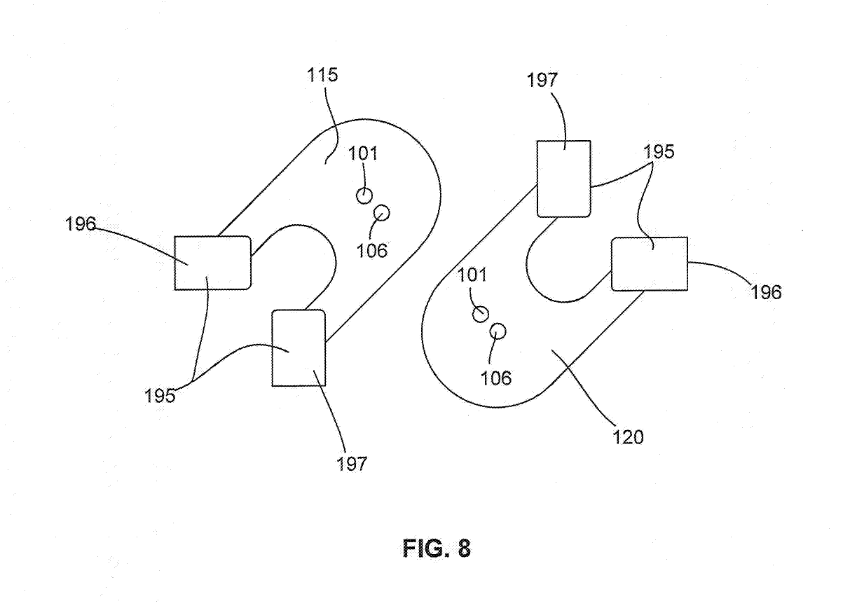

FIG. 9 is a side view of the holding device 300 and shows core 4 assembled to mounting blocks 5 and 10 and adjacent to the shorter brackets 115 and 120 prior to assembly of the brackets 115 and 120 brackets to the mounting blocks 5 and 10. Similar to the device 3 shown in FIG. 4, the brackets 115 and 120 may be attached to the mounting blocks 5 and 10 by means of screws 103 through the slots 40, 42, 45 or 47 and one or both of the screw holes 101 and 106 (shown in FIG. 8) of the brackets 115 and 120. For this example, a single screw 103 is shown in FIG. 7 through shorter slots 42 and 47 of the brackets 115 and 120. However, depending on the shape and configuration of the article being held, one or more screws may instead be used in the long slots 40 and 45. An example tool 171 for tightening screws 103 is shown in FIG. 9, but embodiments are not limited to any particular screws or tightening means. Any suitable connection means may be used.

In other respects display device 300 shown in FIGS. 7 to 9 is structurally and functionally similar to display device 3 described above with reference to FIGS. 1A to 6B. The process of mounting and unmounting the smaller mobile device 31 (or other articles) is also similar to that described above with reference to FIGS. 1A to 6B.

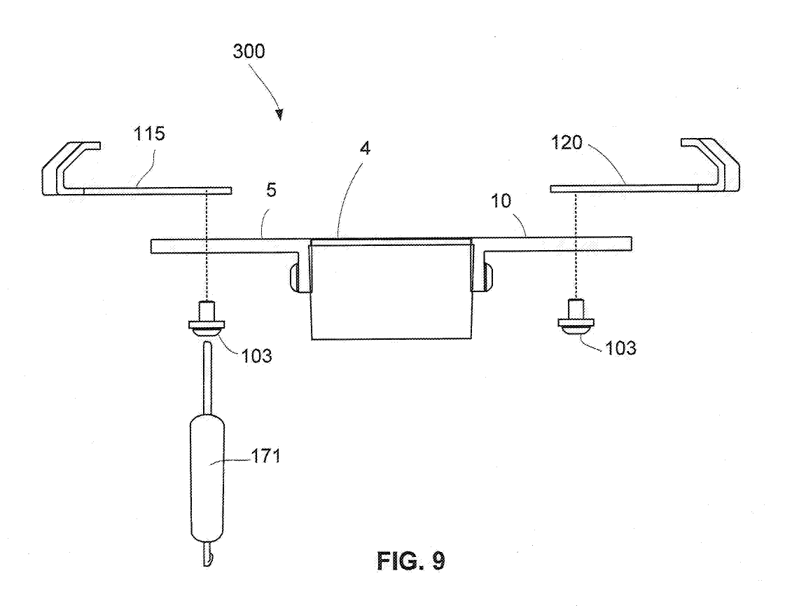

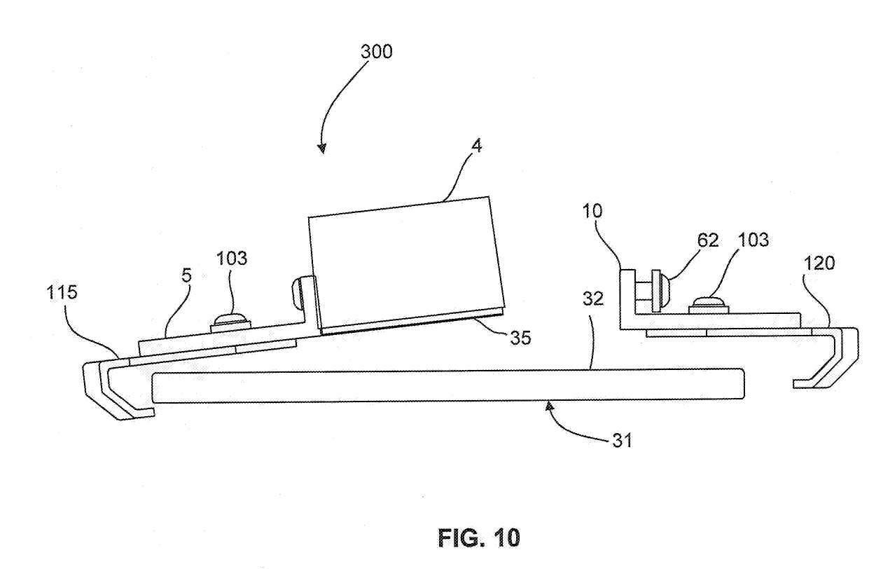

In some embodiments, the central core includes an adhesive with a release or removable layer that may be removed from the central core either before or after the mobile device is secured within the display device. One example method of attaching the device 300 of FIGS. 7 to 9 to the mobile device 31 using an adhesive layer 35 of the central core 4 will now be described with reference to FIGS. 10 and 11. With reference to FIG. 10, the central core 4 has the adhesive layer 35 on its inner surface and a release layer (e.g. paper or plastic with a non-adhering film or coating) initially covering the adhesive layer. Any suitable layer that can removably or releasably cover an adhesive layer may be used.

The device 300 may first be assembled and sized to hole the device 31 as described above by: (1) using screws 62 to first attach the mounting blocks 5 and 10 to the central core 4; (2) using the screws 103 to loosely connect the counting brackets 115 and 120 to the mounting blocks 5 and 10; (3) placing the device 31 in the device 300 and adjusting the brackets to grip the device 31 with the central core optionally generally centered; and (4) tightening the screws 103 connecting the brackets 115 and 120. At this stage, one of the screws 62 may be unfastened from the central core 4 to allow the properly sized device 300 to separate the device 300 into two parts so that it can be temporarily removed from the device 31, as shown in FIG. 10. Specifically, FIG. 10 shows the bracket 120 and mounting block 10 removed from the central core 4. The release layer may then be removed from the adhesive 35, and the central core 4 (with attached bracket 115) may be re-positioned on the device 31 such that the adhesive layer 35 of the central core engages the rear surface 32 of the mobile device 31. The remaining mounting block 10 and bracket 120 may then be re-attached to the central core 4 such that the device 31 is gripped by the both brackets 115 and 120. FIG. 11 shows the holding device 300 holding the mobile device 31, with the device 300 ready to receive the tether 9 in the outer end 23 of the central core.

Other sequences of steps may be taken to attach the holding device 300 to the mobile device 31. Embodiments are not limited to any particular sequence of assembling the holding device 300 or mounting the mobile device 31 in the holding device 300. For example, the mobile device 31 may be placed in the device with the brackets 115 and 120 loosely attached, and then the brackets could be adjusted to the proper positions, but only one of the brackets 115 or 120 then fixed in position by tightening the corresponding screw 103. The remaining loose bracket 115 or 120 could then be extended to allow the holding device 300 to be disengaged from the mobile device 31 to allow the release layer on the adhesive layer 35 of the central core 4 to be removed. Then, the holding device 300 may be placed on the mobile device using the fixed bracket 115 or 120 to properly position the central core 4 on the mobile device 31. The remaining loose bracket 115 or 120 may then fixed in position by tightening the corresponding screw 103.

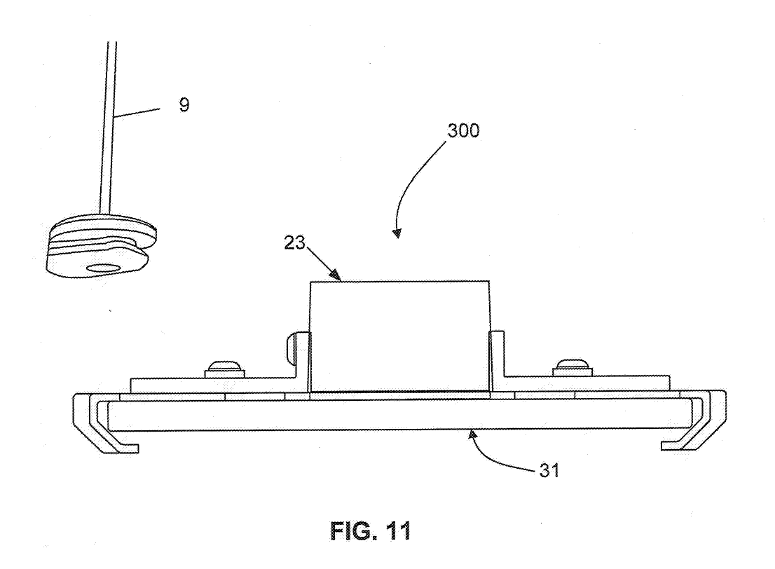

As will be appreciated, the articles to be held and displayed (such as the mobile devices 30 and 31) can be of different depths or thicknesses. Some may be slim and others may be less so. To accommodate varying profiles of different articles, in some embodiments, brackets for the holding device described herein may be provided with claws having different depths as shown in FIGS. 12A to 12D. FIGS. 12A and 12B are side views of two example brackets 215 and 220 respectively that may be used in a holding device to hold an article. These brackets 215 and 220 have claws 295 having a first depth “d1”. FIGS. 12C and 12D are side views of two alternate brackets 315 and 320 respectively that may also be used to hold thicker articles. These brackets 315 and 320 have claws 395 having a second depth “d2” that is larger than the depth “d1” of the brackets 215 and 220 shown in FIGS. 12A and 12B. The example brackets 215, 220, 312 and 320 of FIGS. 12A to 12D may be used, for example, with the central core 4 and mounting blocks described above.

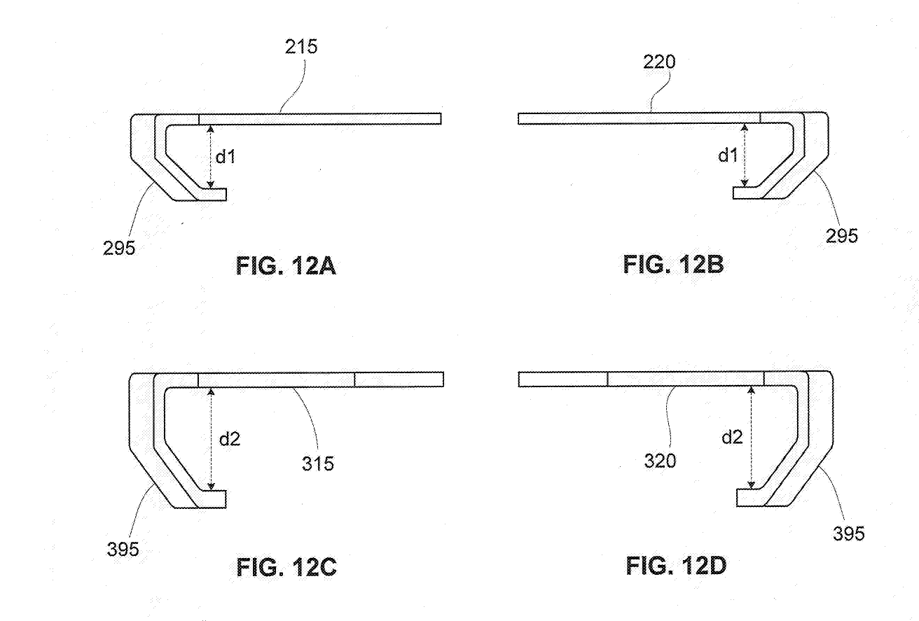

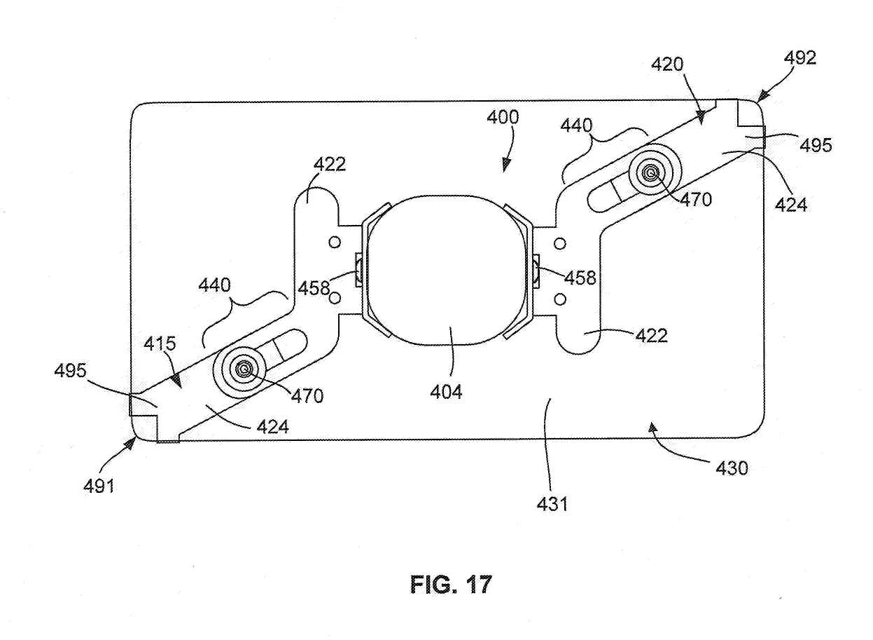

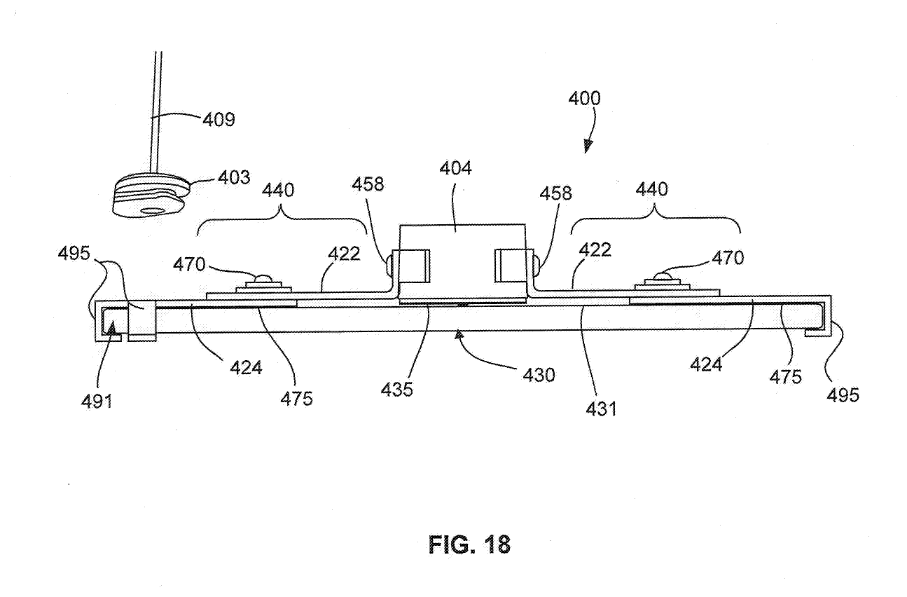

Another embodiment of the disclosure will now be described with reference to FIGS. 13 to 18. FIG. 13 is a top plan view of a holding device 400 according to yet another embodiment. The device 400 includes a central core 404 and first and second brackets 415 and 420 for holding an article (such as a mobile device or tablet). As mentioned above, embodiments are not limited to two brackets only. The first and second brackets 415 and 420 each have a respective outer end 490 and include respective gripping means 495 at the outer end 490 for engaging and holding an article. In this embodiment, the article is in the form of a mobile device 430 (shown in FIGS. 17 and 18). The brackets 415 and 420 are adjustable for lateral movement of the gripping means towards and away from said central core.

The central core 404, in this embodiment is similar to central core 4 of the holding devices 3 and 300 described above with respect to FIGS. 1A to 11. However, there are no mounting blocks attached to the central core 404. Rather, the brackets 415 and 420 are connected directly to the central core 404. The central core 404 is again generally cylindrical and has an outer peripheral side surface 426 with partially flattened sides, including first and second opposite sides 427 and 428. The brackets 415 and 420 are connectable to the central core 404 at the first and second opposite sides 427 and 428 respectively.

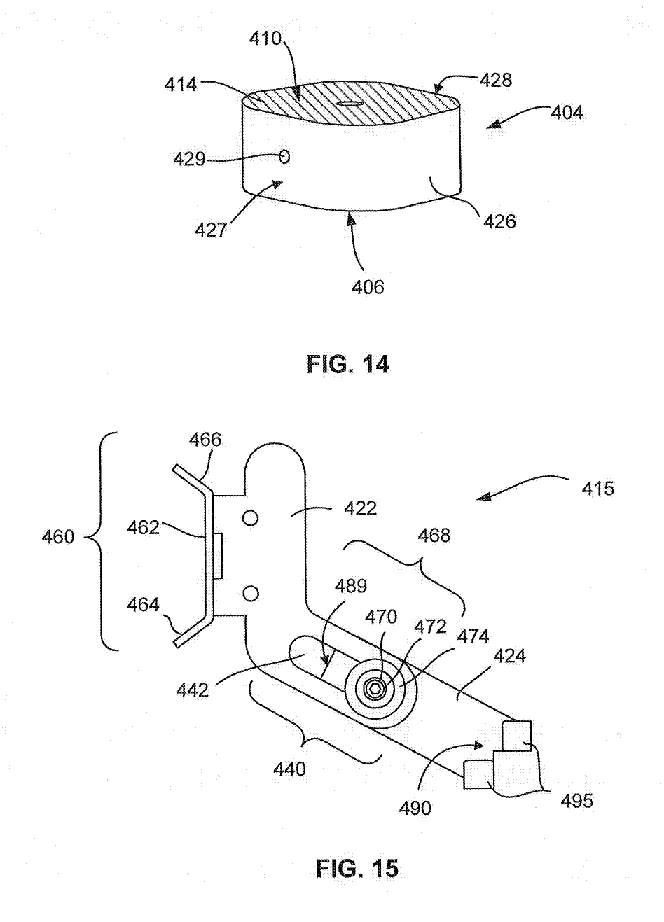

In this embodiment, the brackets 415 and 420, themselves, are adjustable when fixedly connected to the central core 404. Specifically, each of the brackets 415 and 420 includes a respective first bracket piece 422 and a respective second bracket piece 424. This first bracket piece 422 is connectable to the central core 404. The second bracket piece 424 is adjustably connected to the first bracket piece 422 such that the second bracket piece 424 can move laterally, and optionally pivoted, with respect to the first bracket piece 422 and the central core 404. The lateral (and optional pivoting) adjustment of the brackets is provided by a lateral adjustment mechanism 440 connecting the first and second bracket pieces 424 and 424 in this example. The lateral adjustment mechanism 440 in this example is a sliding connection mechanism, which is discussed in more detail below with reference to FIG. 15. In general, the lateral adjustment mechanism 440 allows the brackets 415 and 420 to be adjusted to hold articles (e.g. mobile devices) of different sizes. In this embodiment, the brackets 415 and 420 may grip opposing corners 491 and 492 of the mobile device 430 as shown in FIG. 18.

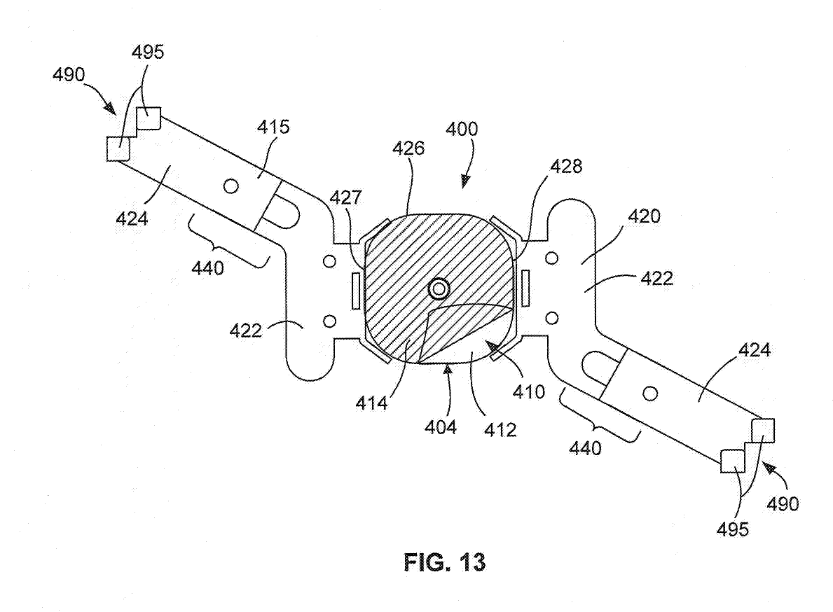

The central core 404 in this embodiment includes an outer end 406 (shown in FIG. 14) and an inner end 410. The inner end 410 is substantially flat and is covered by an adhesive layer 412, which, in turn, is initially covered by a removable or releasable layer 414. The removable layer 414 is shown partially peeled back in FIG. 13 so that the adhesive layer 412 is partially visible.

FIG. 14 is a perspective view of the central core 404 of the holding device 400 shown in FIG. 13.

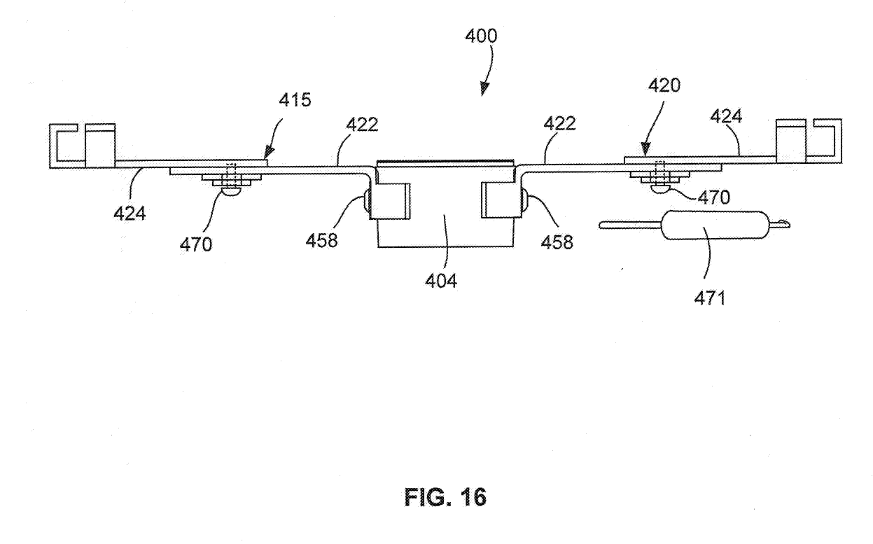

The central core 404 includes threaded holes 429 in each of the first and second opposite sides 427 and 428 of the central core for receiving a screw 458 (shown in FIGS. 16 and 17) to fasten the brackets 415 and 420 (shown in FIG. 13) to the central core 404. In some embodiments, the outer end 406 of the central core 404 may include a docking station (not shown) for receiving a docking end of a tether or display arm. For example a docking station in the central core may define a recess (not shown) for receiving a docking end 403 of tether 409 shown in FIG. 18 in a locking, releasable manner. As described above, the holding devices described herein may be connected to any suitable tether or display means. Other means for connecting a core to a tether or display arm (such as screws, snaps, ties or any other suitable fastening means) may be used. Conventional cores that include tethering means for attaching to an article for display are available from MTI Industries and may be used or modified to be used with the brackets 415 and 420 described herein. However, embodiments of the holding device described herein are not limited to any particular core, as mentioned above.

FIG. 15 is a bottom plan view of the first bracket 415 of the device 400 shown in FIG. 13. The second bracket 420 (shown in FIG. 13) is essentially identical to the first bracket 415 in this embodiment, although it is to be understood that brackets are not necessarily all identical in other embodiments.

The bracket 415 includes the first bracket piece 422 and the second bracket piece 424, which are adjustably connected by the lateral adjustment mechanism 440. The first bracket piece 422 is generally an obtuse angled L-shape with a first elongated section 460 and second elongated section 461 at an obtuse angle to the first elongated section 460. The first bracket piece 422 also includes a wall portion 462 that is integral with first elongated section 460. The wall portion 462 runs parallel to the length of the first elongated section 460 and has a width extending orthogonal to the first elongated section 460. The wall portion 462 has angled ends 464 and 466 and is shaped to generally fit around the first side 427 of the central core 404 (shown in FIG. 14). The wall portion 462 includes a hole (not shown) that aligns with the threaded hole 429 of the central core to receive a screw 458 (shown in FIG. 16) to fasten the bracket 415 to the central core 404. The second elongated section 468 defines an elongated slot 442 therethrough.

The second bracket piece 424 is elongated and includes a threaded hole (not shown) near an inner end 489 (opposite to the outer end 490 with the gripping means 495) that is for receiving a screw 470. The screw 470 extends through the slot 442 of the first bracket piece 422 and into the threaded hole. In this example, two optional washers 472 and 474 are included between the head of the screw 470 and the first hinge piece 422. The screw 470 and the slot 442 together form the lateral adjustment means 440. In this embodiment, the screw is guided in, and restricted by the slot 442 to allow the lateral sliding movement (and optional pivoting) of the second bracket piece 424 with respect to the first bracket piece 422. The screw can be tightened to fix the first and second bracket pieces 422 and 424 in a particular position or loosened to allow the lateral movement (and optional pivoting) for adjustment of the bracket 415. In other embodiments, the second bracket piece 424, rather than the first bracket piece 422, may contain the slot 442.

As also shown in FIG. 15, the gripping means 495 in this embodiment are claws that are generally fork-like with two claw prongs, similar to the gripping means 95 and 195 of the holding devices 3 and 300 described with reference to FIGS. 1A to 11. Other gripping means configurations may also be used. For example, gripping means such as a clamp, a curved flange forming a groove or channel, a bolt, an adhesive or any other suitable other means of holding or gripping an article may be used.

The particular structure and shape of the brackets 415 and 420 is exemplary and embodiments are not limited to the particular example shown in FIG. 15.

FIG. 16 is a side view of the assembled holding device 400. FIG. 16 also shows an example tool 471 that may be used to tighten and/or loosen screws 458 (holding the brackets 415 and 420 to the central core 404) or screws 470 (connecting the first and second hinge pieces 422 and 424 of the brackets 415 and 420). The tool 471 may, for example, be a security AllenCap tool. However, embodiments are not limited to any particular fastening means or tool for adjusting the fastening means.

FIG. 17 is a bottom view of the holding device 400 of FIGS. 13 and 16 holding the mobile device 430. FIG. 18 is a side view of the holding device 400 and the mobile device 430. FIG. 18 also shows tether 409 that may attach to the central core 404, as described above. As shown in FIG. 17, the angle and shape of the bracket is such that the claws 495 are positioned on the opposite corners 491 and 492 of the mobile device in this embodiment. The angle of the bracket may be varied, and/or the second bracket piece may be pivoted to fit other shaped articles. For example, the angle, size, and/or distance of lateral adjustment provided by the brackets may vary in other embodiments depending on the size and shape of the article to be held and displayed.

The procedure for attaching the holding device 400 to the mobile device 430 may be similar to the example procedures described above for the devices 3 and 300 (shown in FIGS. 1A to 11). For example, the brackets 415 and 420 may first be attached to the central core 404 by means of screws 458. The screws 470 in the lateral adjustment mechanisms 440 may initially be left in a loose state. The brackets 415 and 420 adjusted to an extended position large enough for the mobile device 430 to be placed on an inner surface 475 of the second bracket pieces 424 and the inner side 410 of the central core 404. The brackets 415 and 420 may then be retracted until the claws 495 of each bracket grips and holds the mobile device 430. The central core 404 may be moved to a suitable (e.g. central) position against the rear surface 431 of the mobile device 430. Next, the lateral adjustment mechanism 440 of one of the two brackets 415 or 420 may be fixed in position by tightening the corresponding screw 470. The other bracket 415 or 420 may be again extended to allow the central core 404 to be moved axially away from the mobile device 430 for removal of the layer 414 covering the adhesive layer 412 of the central core 404. The central core may be placed back against the mobile device, this time forming a bond with the mobile device 430 via the adhesive layer. Finally, the remaining loose bracket 415 or 420 may be retracted to the position holding the mobile device 430 and fixed in that position by tightening the screw 470 of the corresponding lateral adjustment mechanism 440.

Other sequences of steps or variations of the method described above may performed to hold the mobile device 430 in the holding device 400. For example, after initially adjusting the brackets 415 and 420 to grip the mobile device and position the central core 404, both brackets 415 and 420 may be fixed in position (by tightening both screws 470). Then, the screw 458 holding one of the brackets 415 or 420 may be loosened to temporarily disconnect from the central core 404. This would allow the central core 404 to be moved away from the mobile device 430 for access to the removable layer 414. Once the removable layer 414 is removed to expose the adhesive layer 412, the central core 404 may be placed back against the mobile device and the previously removed bracket 415 or 420 may be reattached. Other methods may also be used to mount or hold the mobile device 430 (or other articles) in the holding device 400.

Optionally, the removable layer 414 may be removed before the mobile device is initially placed on the holding device 400. Then, the central core 404 could be carefully placed in the desired position against the mobile device 430, and both brackets may be retracted to grip the mobile device and fixed in position. As another option, the adhesive layer 412 and/or steps to expose the adhesive layer 412 may be omitted.

As with the holding devices 3 and 300 described with reference to FIGS. 1A to 11, the holding device 400 may be modified by replacing one or both brackets 415 and 420 with brackets shaped and or otherwise configured to hold a different range of articles. For example, larger, smaller, or differently shaped brackets could be used in conjunction with the central core 404 to hold various sized and shaped articles as needed.

As will be appreciated, the adjustable nature of the holding devices described herein (including example holding devices 3, 300 and 400 shown in the figures) may allow articles of various sizes and configurations to be held and displayed.

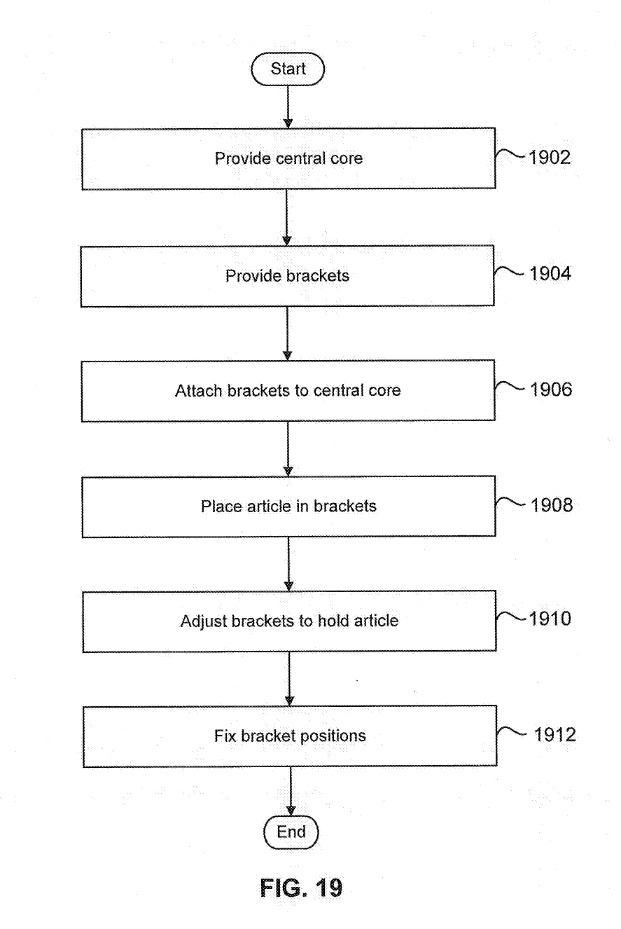

FIG. 19 is a flowchart of a method of holding an article for display. The method may be performed with the holding device as described above (such as the holding device 3, 300 or 400 described above with reference to FIGS. 1A to 18). At block 1902, a central core is provided. At block 1904, a plurality of brackets are provided, where the brackets are connectable to the central core, and each bracket has a respective outer end and includes respective gripping means at the outer end for engaging and holding the article. For blocks 1902 and 1904, the term “provide” may include manufacturing, purchasing, or otherwise acquiring or obtaining. At block 1906, the plurality of brackets are attached to the central core such that the plurality of brackets are adjustable for lateral movement of the gripping means towards and away from said central core when attached. At block 1908, the article is placed in the brackets. At block 1910, the brackets are adjusted such that the gripping means hold the article. At block 1912, the brackets are fixed in their respective positions holding the article.

The method above may optionally include steps of exposing an adhesive layer on the central core and/or affixing the core to the article using the adhesive layer as described above. For example, between blocks 1910 and 1912, steps to move the central core to provide access for removing a releasable layer may be performed (such as any of the steps described above for the holding devices 3, 300 or 400 described above with reference to FIGS. 1A to 18). The method may also include removing one set of brackets and replacing it with a new set of brackets for a different sized article. The method may also include pivoting one or more brackets or bracket pieces as part of the bracket adjustment process.

The components of the holding devices (e.g. central core, mounting blocks, and/or brackets) described herein may be made of any suitable material for holding and displaying an article. For example, rigid materials such as metal or metal-reinforced plastic may be used. Embodiments of the disclosure, such as those described with reference to FIGS. 1A to 19, are not limited to any particular material used for the components of the device.

It is to be understood that a combination of more than one of the above approaches may be implemented in some embodiments. Embodiments are not limited to any particular one or more of the approaches, methods or apparatuses disclosed herein. One skilled in the art will appreciate that variations, alterations of the embodiments described herein may be made in various implementations without departing from the scope thereof. It is therefore to be understood that within the scope of the appended claims, the disclosure may be practiced otherwise than as specifically described herein.

What has been described is merely illustrative of the application of the principles of the invention. Other arrangements and methods can be implemented by those skilled in the art without departing from the scope of the present invention.

1. A holding device for display of an article, the holding device comprising:
a central core; and
a plurality of brackets connectable to the central core, each of said plurality of brackets having a respective outer end and comprising respective gripping means at the outer end for engaging and holding the article, wherein
the plurality of brackets are adjustable for lateral movement of the gripping means towards and away from said central core.

2. The holding device of claim 1, wherein the plurality of brackets comprise first and second brackets, the central core having first and second opposite sides, and the first and second brackets being connectable to the first and second sides respectively.

3. The holding device of claim 1, wherein each of said brackets comprises:
a respective first bracket piece that is connectable to said central core;
a respective second bracket piece that is adjustably connected to the first bracket piece for said lateral movement, such that said plurality of brackets are adjustable to hold articles of different sizes.

4. The holding device of claim 3, wherein, for each said bracket, the second bracket piece is slidably connected to said first bracket piece.

5. The holding device of claim 4, wherein, for each said bracket, one of the first and second bracket pieces comprises an elongated slot, and the first and second bracket pieces are connected by a fastening member that extends through said slot, whereby said slot guides the sliding movement of the second bracket piece relative to the first bracket piece.

6. The holding device of claim 5, wherein, for each said bracket, the fastening member movable within said slot for said lateral movement, and the fastening member is tightenable to hold said second bracket piece in a fixed position relative to the respective first bracket piece.

7. The holding device of claim 1, wherein the gripping means of each bracket is for engaging a respective corner of the article.

8. The holding device of claim 7, wherein the gripping means of each bracket comprises respective claws.

9. The holding device of claim 8, wherein the claws of each bracket comprise a respective first claw prong and a respective second claw prong, the first and second claw prongs for engaging perpendicular edges of the article at the respective corner.

10. The holding device of claim 1, wherein said central core has a peripherally extending side surface, a first end surface oriented to face the article being held and a second end surface spaced from said first end surface by said peripherally extending side surface.

11. The holding device of claim 10, wherein said plurality of brackets are connectable to said peripherally extending side surface of said central core.

12. The holding device of claims 10, wherein the first end surface of the central core is adjacent to a surface of the article when the article is held by the holding device, said central core comprising an adhesive layer on the first end surface.

13. The holding device of claim 1, wherein the holding device comprises first and second mounting blocks releasably attached to the central core, the plurality of brackets comprising first and second brackets respectively and adjustably connectable to said first and said mounting blocks for said lateral movement.

14. The holding device of claim 13, wherein said first and second brackets are slidably connectable to respective ones of said mounting blocks, such that said brackets are adjustable to hold articles of different sizes.

15. The holding device of claim 14, wherein each of said mounting blocks is formed with at least one elongated slot for receiving therethrough a fastening member connectable to a respective one of said brackets, whereby said slot guides the sliding movement of said bracket means.

16. The holding device of claim 15, wherein said fastening member is tightenable to hold said bracket means in a fixed position relative to its respective mounting block.

17. An adjustable bracket for a holding device comprising a central core, the adjustable bracket comprising:
a first bracket piece that is connectable to said central core; and
a second bracket piece having an outer end and comprising gripping means at the outer end for engaging and holding the article,
said second bracket piece being adjustably connected to the first bracket piece for lateral movement of the gripping means towards and away from said central core, such that said bracket is adjustable to hold articles of different sizes.

18. The adjustable bracket of claim 17, wherein the bracket is connectable to a side of the central core.

19. The adjustable bracket of claim 18, wherein the second bracket piece is slidably connected to said first bracket piece.

20. The adjustable bracket of claim 19, wherein one of the first and second bracket pieces comprises an elongated slot, and the first and second bracket pieces are connected by a fastening member that extends through said slot, whereby said slot guides the sliding movement of the second bracket piece relative to the first bracket piece.

21. The adjustable bracket of claim 20, wherein the fastening member is movable within said slot for said lateral movement, and the fastening member is tightenable to hold said second bracket piece in a fixed position relative to the respective first bracket piece.

22. The adjustable bracket of claim 21, wherein the gripping means is for engaging a corner of the article.

23. The adjustable bracket of claim 22, wherein the gripping means comprises respective claws.

24. The adjustable bracket of claim 23, wherein the claws comprise a respective first claw prong and a respective second claw prong, the first and second claw prongs for engaging perpendicular edges of the article at the corner of the article.

25. A method of holding an article, comprising:
providing a central core;
providing a plurality of brackets connectable to the central core, each of said plurality of brackets having a respective outer end and comprising respective gripping means at the outer end for engaging and holding the article;
attaching the plurality of brackets to the central core, wherein plurality of brackets are adjustable for lateral movement of the gripping means towards and away from said central core;
placing the article in the brackets;
adjusting the brackets such that the gripping means hold the article; and
fixing the brackets in their respective positions holding the article.
